(19) United States
(12) Patent Application Publication
(10) Pub. No.: US 2007/0155372 A1
(43) Pub. Date: Jul. 5, 2007

(54) Method and system for detecting a mobile model

(75) Inventor: Lung-Chu Huang, Sindian City (TW)

Correspondence Address: BACON & THOMAS, PLLC, 625 SLATERS LANE, FOURTH FLOOR, ALEXANDRIA, VA, 22314, US

(73) Assignee: Mobile Action Technology Inc., Sindian City (TW)

(21) Appl. No.: 11/324,318

(22) Filed: Jan. 4, 2006

(51) Int. Cl. H04M 3/00

(52) U.S. Cl. 455/418

(57) ABSTRACT

A method and system for detecting a mobile model are provided. The system gathers model IDs by receiving a customized massage from a sender and then storing the model ID, issuing a WAP PUSH message containing an access URL to a mobile station, receiving a request with a UserAgent attached and mobile phone number from a mobile station, adding a new record of the mobile phone number and its corresponding UserAgent into a ID database when the UserAgent is not in the mapping table.

### BACKGROUND OF THE INVENTION

1. Field of the Invention

The present invention relates to a method and system, and more particularly to the method and the system for detecting a mobile model.

2. Description of Related Art

In the last several years, mobile phones have become more popular and widely used than personal computers, and people have become more dependent on mobile phones as the mobile phone has become more integrated into daily life. Currently, an estimated 1.5 billion people worldwide own mobile phones.

Mobile commerce is already been widely used to provide business information by mobile operators or network service providers. A well-known technique to implement mobile commerce is WAP PUSH, which provides the ability to enable a user to directly download links on specific mobile operators or network service providers by sending a link via SMS that automatically launches when the message is opened.

However, because each mobile phone has unique capabilities, an incompatible data format downloaded via a mobile-web browser will causes unanticipated problems.

To overcome the shortcomings, the present invention provides a method and system for detecting a mobile model to obviate or mitigate the aforementioned problems.

### SUMMARY OF THE INVENTION

The main objective of the present invention is to provide a method and system for detecting a mobile model, which allows a user to download a proper data format to his/her mobile station by linking a URL attached in a meaningful message.

To accomplish the foregoing objective, the system for detecting a mobile model comprises a network server, a client unit and a mobile station.

The network server has a main server, an application server, a mapping table and an ID database. The main server can issue a WAP PUSH message via a message service of a telecommunications service provider having a switching system with multiple wireless applications protocol (WAP) gateways that deliver requests to the network server.

The client unit has a built-in network user interface and uplink driver, that allow a sender to create a customized message including personalized ring/tone/image/note to a recipient by network user interface and put the message on the network server via uplink driver.

The mobile station has an embedded mobile management interface and a UserAgent. The mobile management interface receives WAP PUSH messages from the network server, and the UserAgent identifies the basic information of the mobile station. Recipients' mobile stations send requests to the WAP gateways.

The method and the system for detecting a mobile model in accordance with the present invention comprises sequential steps of (1) creating and transmitting a customized message, (2) storing the customized message, (3) issuing a WAP PUSH message, (4) receiving a request, (5) comparing the UserAgent and (6) adding a new record. The step of transmitting a customized message comprises a sender creating a customized message with a personalized ring/tone/image/note in a client unit and transmitting the customized message to the main server in the network server. In the storing the customized message step, the customized message is stored in the application server in the network server. The issuing a WAP PUSH message step comprises issuing a WAP PUSH message to a recipient, which contains a URL linked to the network server. In the step of receiving a request, the request from a mobile station contains the UserAgent of the recipient's mobile station and the recipient's mobile phone number, and then the UserAgent is extracted. The step of comparing the UserAgent comprises comparing the UserAgent from the request with the UserAgent in a mapping table in the network server. In the step of adding a new record step, a new record with the mobile phone number and its corresponding UserAgent will be added into the ID database if the UserAgent can not be found in the mapping table or else a new record with the mobile phone number and its corresponding model ID will be created into the ID database if the UserAgent exists in the mapping table.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a system for detecting a mobile model in accordance with the present invention; and

FIG. 2 is a functional flow diagram of a method for detecting a mobile model in accordance with the present invention.

### DETAILED DESCRIPTION OF THE PREFERRED EMBODIMENT

A system and method for detecting a mobile model in accordance with the present invention are provided.

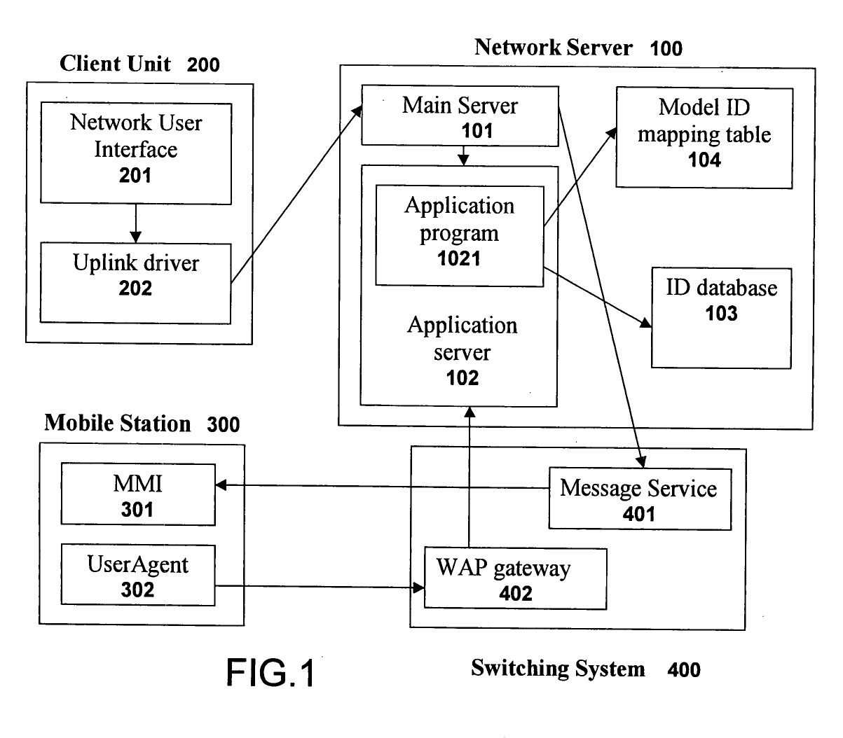

With reference to FIG. 1, the system issues WAP PUSH messages and receives customized messages through a switching system (400) having a message service (401) and multiple wireless applications protocol (WAP) gateways (402) and comprises a network server (100), a client unit (200) and a mobile station (300).

The network server (100) issues WAP PUSH messages through the message service (401) in a switching system (400) and has a main server (101), an application server (102), an ID database (103) and a mapping table (104).

The main server (101) receives customized messages including personalized ring/tone/image/note via the Internet.

The application server (102) stores a customized message sent by a sender, identifies a mobile station and has a built-in application program (1021).

The ID database (103) contains records with a mobile phone number field and a model ID field. The mobile phone number field contains a mobile phone number of a specific mobile station, and the model ID field contains a model ID corresponding to a mobile phone model number on which the mobile phone number is used.

The mapping table (104) contains records with a UserAgent field and a model ID field.

The client unit (200) can be a personal computer and has a built-in network user interface (201) and uplink driver (202).

The network user interface (201) is used to create a customized message including personalized ring/tone/image/note.

The uplink driver (202) establishes a connection between the client unit (200) and the network server (100).

The mobile station (300) has a built-in a MMI (mobile management interface) (301) to allow a user to receive a WAP PUSH message from the network server (100) and a UserAgent (302).

The UserAgent (302) is a code to identify basic capabilities about a specific mobile station (300), such as screen size, color capabilities, image capabilities, audio capabilities, manufacturer, etc.

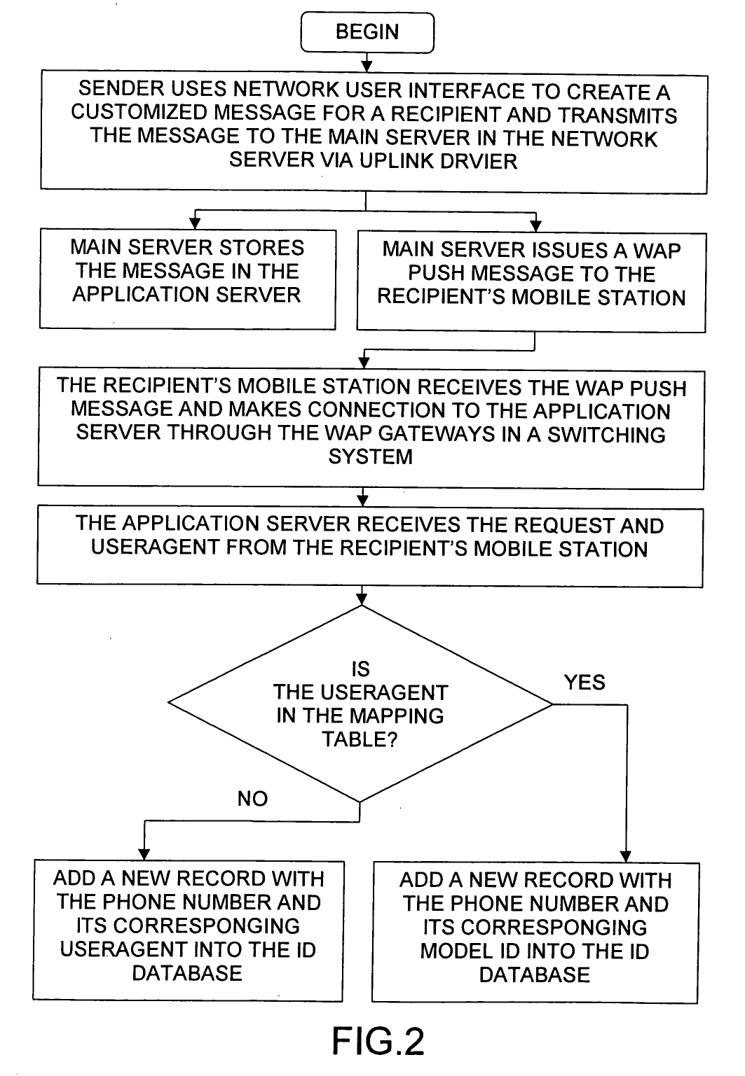

With reference to FIG. 2, the method for detecting a mobile model uses the previously described system and comprises the steps of (1) creating and transmitting a customized message, (2) storing the customized message, (3) issuing a WAP PUSH message, (4) receiving a request, (5) comparing the UserAgent and (6) adding a new record:

The step of creating and transmitting a customized message comprises a sender using a network user interface (201) to create a customized message with a personalized ring/tone/image/note in a client unit (200) and transmitting the customized message through an uplink driver (202) in the client unit (200) to a recipient through the main server (101) in a network server (100).

In the storing the customized message step, the main server (101) stores the customized message in the application server (102).

In the issuing a WAP PUSH step, the main server (101) simultaneously with the previous step issues a WAP PUSH message to the recipient's mobile station (300) via the message service (401) of the switching system (400) when a request is received from a sender. The WAP PUSH message contains:
a URL linking to the network server (100) and
a personalized note.

a mobile station (300) that receives a WAP PUSH message can submit a request via the MMI (301) through the WAP gateways (402) of the switching system (400) to the application server (102) to view the customized message created by the sender and stored in the application server (102).

When the request is sent, the UserAgent (302) stored in the recipient's mobile station (300) and the recipient's mobile phone number are attached to the request.

In the receiving a request step, the application server (102) receives the request from the recipient's mobile station (300), which contains the UserAgent (302) of the recipient's mobile station (300) and the recipient's mobile phone number.

In the comparing the UserAgent (302) step, the application program (1021) in the application server (102) compares the UserAgent (302) from the request with the UserAgent field in the mapping table (104) in the network server (100) and takes one of the following actions.

In the adding a new record step, if the UserAgent (302) from the request is not in the mapping table (104), a new record with the mobile phone number and its corresponding UserAgent (302) will be added into the ID database (103) by the application program (1021).

If the UserAgent (302) exists in the mapping table (104), a new record with the mobile phone number and its corresponding model ID will be created in the ID database (103) by the application program (1021).

Whereby, the attached rings/tones/images will be scaled to fit the mobile station (300) before sending a meaningful message by the network service providers.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A system for detecting a mobile model, which issues WAP PUSH messages and receives customized messages through a switching system having a message service and multiple wireless applications protocol (WAP) gateways, the system comprising
the network server issuing WAP PUSH messages through the message service in a switching system and having
a main server receiving a customized message sent by a sender;
an application server storing a customized message, identifying a mobile station and having a built-in application program;
an ID database containing multiple records respectively having
a mobile phone number field with a mobile phone number and
a model ID field with a model ID corresponding to a mobile phone model number on which the mobile phone is used; and
a mapping table having a UserAgent field and a model ID field;
a client unit having
a network user interface to allow a user to create a customized message including personalized ring/tone/image/note; and
an uplink driver establishing a connection between the client unit and the network server;
a mobile station having
a mobile management interface to allow a user to receive a WAP PUSH message from the network server; and
a UserAgent being a code to identify basic capabilities about a mobile station.

2. The system as claimed in claim 1, wherein the client unit is a personal computer.

3. A method for detecting a mobile model using the system claimed in claim 1 and comprising steps of:
creating and transmitting a customized message comprising a sender using a network user interface in a client unit to create a customized message with a personalized ring/tone/image/note and transmitting the customized message through an uplink driver in a client unit to a recipient through the main server in a network server;
storing the customized message comprising the main server storing the customized message in an application server of the network server;
issuing a WAP PUSH message comprising the main server simultaneously with the previous step issuing a WAP PUSH message to a recipient's mobile station via the message service of the switching system when a request is received from a sender; a mobile station that receives the WAP PUSH message can submit a request to view the customized message;
receiving a request comprising the application server receiving a request from the mobile station, which contains the UserAgent of the recipient's mobile station and the recipient's mobile phone number;
comparing from the request with the UserAgent with the UserAgent field in the mapping table in the network server;
adding a new record comprises adding a new record with the mobile phone number and its corresponding UserAgent into the ID database if the UserAgent from the request is not in the mapping table and creating a new record with the mobile phone number and its corresponding model ID in the ID database If the UserAgent from the request exists in the mapping table.
